(19) United States
(12) Patent Application Publication
(10) Pub. No.: US 2025/0357604 A1
(43) Pub. Date: Nov. 20, 2025

(54) BATTERY PACK

(71) Applicant: SAMSUNG SDI CO., LTD., Yongin-si, Gyeonggi-do (KR)

(72) Inventors: Dongwoo KIM, Yongin-si, Gyeonggi-do (KR); Seongseop KIM, Yongin-si, Gyeonggi-do (KR); Sangil YI, Yongin-si, Gyeonggi-do (KR); Hyeoksoo HONG, Yongin-si, Gyeonggi-do (KR)

(73) Assignee: SAMSUNG SDI CO., LTD., Yongin-si, Gyeonggi-do (KR)

(21) Appl. No.: 18/871,094

(22) PCT Filed: Jun. 1, 2023
(86) PCT No.: PCT/KR2023/007508

§ 371 Date: Dec. 2, 2024

(30) Foreign Application Priority Data
Jun. 2, 2022 (KR) 10-2022-0067695

(51) Int. Cl. H01M 50/258; H01M 10/04; H01M 50/103; H01M 50/209; H01M 50/242; H01M 50/264

(52) U.S. Cl. CPC H01M 50/258; H01M 10/049; H01M 50/103; H01M 50/209; H01M 50/242; H01M 50/264

(57) ABSTRACT

In the present disclosure, a battery pack is disclosed. The battery pack includes multiple battery units arranged along a first axis, wherein each battery unit includes an electrode assembly, and a case accommodating the electrode assembly, wherein the case has first and second sides facing each other along the first axis, the first side has a movable surface enabling positional movement in the first axis, and the second side has a protruding surface that protrudes in a direction away from the first side along the first axis. According to the present disclosure, provided is a battery unit in which effective pressure is provided to an electrode assembly forming the interior of the battery unit from the bonding force which physically binds multiple battery units by forming a movable surface on one side of a case which forms the exterior of the battery unit.

### TECHNICAL FIELD

The present disclosure relates to a battery pack.

### BACKGROUND ART

Typically, secondary batteries can be charged and discharged, unlike primary batteries which are not rechargeable. The secondary batteries are used as an energy source for mobile devices, electric vehicles, hybrid vehicles, electric bicycles, and uninterruptible power supplies. Depending on the type of external devices to which the secondary batteries are applied, the secondary batteries may be used in the form of a single battery or may also be used in the form of modules in which multiple batteries are connected to form a single unit.

### DISCLOSURE OF INVENTION

### Technical Problem

An embodiment of the present disclosure includes a battery unit in which effective pressure is provided to an electrode assembly forming the interior of the battery unit from the bonding force which physically binds multiple battery units by forming a movable surface on one side of a case which forms the exterior of the battery unit.

An embodiment of the present disclosure includes a battery unit which may prevent the output characteristics of the electrode assembly from deteriorating through effective compression of the electrode assembly and may include multiple electrode layers to be suitable for high capacity and high output at high voltage.

### Solution to Problem

To solve the technical problems mentioned above and other problems, a battery pack of the present disclosure including multiple battery units arranged along a first axis is provided. Each battery unit includes an electrode assembly, and a case accommodating the electrode assembly, wherein the case has first and second sides facing each other according to the first axis, wherein the first side has a movable surface enabling positional movement according to the first axis, and the second side has a protruding surface that protrudes in a direction away from the first side along the first axis.

For example, the positional movement of the movable surface may include a movement in a direction of pressing the electrode assembly between the first and second sides.

For example, the battery unit further may include a side connecting the first side to the second side, and the positional movement of the movable surface may include a sliding movement guided along the side.

For example, between adjacent battery units according to the first axis, a movable surface in the first side may receive pressure from a protruding surface of a second side of another adjacent battery unit and may move along the first axis.

For example, the movable surface of the first side may move toward the second side of the same battery unit in which the first side is included and presses the electrode assembly between the first and second sides.

For example, the first side further may include a first edge portion surrounding the movable surface on the outer side of the movable surface which is relatively distant from the second side, and the second side may further include a second edge portion surrounding the protruding surface on the inner side of the protruding surface which is relatively close to the first side.

For example, an exposed region of the movable surface exposed from the first edge portion and the protruding surface may be formed at positions corresponding to each other.

For example, the first edge portion may be formed to be stepped from the movable surface toward the outer side away from the second side, and the second edge portion may be formed to be stepped from the protruding surface toward the inner side approaching the first side.

For example, the case may include a can integrally formed from the first edge portion of the first side to a side connecting the first side to the second side and the entire second side.

For example, in the arrangement of multiple battery units arranged along the first axis, the first and second sides may be arranged alternately along the first axis.

For example, in the arrangement of multiple battery units arranged along the first axis, the first and second sides may be placed at one end location and the other end location, respectively, which correspond to the outermost positions in the first axis.

For example, on the outside of the first side at the outermost location along the first axis, a pressure plate having a protruding surface for providing pressure to a movable surface of the first side may be arranged.

For example, the battery pack may further include a binding mechanism that provides a binding force to physically bind the multiple battery units arranged along the first axis.

For example, the binding force provided by the binding mechanism may be transmitted along the first axis in which the multiple battery units are arranged, providing a pressure that induces the positional movement of the movable surface in the first side in each battery unit.

For example, the binding mechanism includes a pair of end plates including a front end plate and a rear end plate respectively formed outside one end location and the other end location in the first axis, in the arrangement of multiple battery units arranged along the first axis, and a pair of side plates extending across the sides of multiple battery units arranged along the first axis and connecting the front end plate to the rear end plate.

For example, one end plate of the front end plate and the rear end plate may include a protruding surface for providing pressure to the movable surface of the outermost first side along the first axis.

For example, the movable surface may provide elasticity or cushioning between adjacent battery units to absorb swelling of multiple battery units arranged along the first axis.

For example, the movable surface may include an elastic material.

For example, the electrode assembly may include multiple electrode layers stacked along the first axis.

For example, the electrode assembly may include an electrolyte layer between electrode layers of different polarities along the first axis, and the electrolyte layer may include a solid electrolyte.

For example, the battery pack may further include an alignment mechanism for aligning multiple electrode layers arranged along the first axis.

For example, the alignment mechanism may include guide columns extending along the first axis to pass through corresponding positions of multiple electrode layers arranged along the first axis or corresponding positions of gaskets surrounding the outer circumferences of multiple electrode layers.

For example, the electrode layer may include first and second electrode layers of different polarities.

The guide columns may continuously pass through the first electrode layer and the gaskets surrounding the outer circumferences of the second electrode layer and may align the first electrode layer with the second electrode layer surrounded by the gaskets.

For example, the gasket may include a central opening defining the correct location of the second electrode layer, and an edge surrounding the central opening.

For example, the gasket may include a pair of strips arranged to face each other while extending in a direction of the long side of the second electrode layer, and another pair of strips arranged to face each other while extending in a direction of the short side of the second electrode layer, and through-holes formed at four corner positions where the pair of strips extending in the direction of the long side and another pair of strips extending in the direction of the short side come into contact with each other.

The guide columns continuously pass through through-holes formed at four corner positions of the gaskets and through-holes formed at four corner positions of the second electrode layer.

### Advantageous Effects of Invention

According to an aspect of the present disclosure, provided is a battery unit in which effective pressure is provided with respect to an electrode assembly, which forms the interior of the battery unit, with the bonding force for physically binding multiple battery units arranged according to a first axis, by forming a movable surface on one side of a case which forms the exterior of the battery unit.

According to another aspect of the present disclosure, by using an electrode assembly including a solid electrolyte with the relatively low risk of electrolyte leakage, the movable surface may be formed on one side of the case that accommodates the electrode assembly, and the electrode assembly may be effectively pressed according to the positional movement or sliding movement of the movable surface.

According to another aspect of the present disclosure, through effective compression of the electrode assembly according to the positional movement of the movable surface, the deterioration of the output due to increased swelling of the electrode assembly accompanying the relatively thick thickness may be suppressed while using the electrode assembly including multiple electrode layers to provide high capacity and high output at high voltage. In particular, the deterioration of the output due to poor contact between the electrolyte layer including the solid electrolyte and the electrode layer or uneven contact pressure may be prevented.

According to another aspect of the present disclosure, by applying a can-type case with relatively increased rigidity to the other portions of the case than the movable surface, the case damage, such as tearing, that may result from manufacturing cases with the increased depth to accommodate the relatively thick electrode assembly, may be prevented. In addition, the increased rigidity of the case may effectively suppress swelling, which can be noticeable in the relatively thick electrode assembly.

According to another aspect of the present disclosure, in the arrangement of multiple battery units arranged according to the first axis, swelling that propagates cumulatively along the first axis may be absorbed through the movable surface that causes the positional movement or provides elasticity or cushioning between neighboring battery units. The movable surface may block the physical and electrical interference between the neighboring battery units.

### BRIEF DESCRIPTION OF DRAWINGS

FIG. 1 is a perspective view of a battery pack according to an embodiment of the present disclosure.

FIGS. 2A and 2B are different perspective views of a first side and a second side of a battery unit shown in FIG. 1, respectively.

FIG. 3 is a cross-sectional view of the battery unit, taken along line A-A in FIG. 2A.

FIG. 4 is a perspective view of a pressure plate shown in FIG. 1.

FIG. 5 is an exploded perspective view of the battery unit shown in FIG. 1.

FIG. 6 is another exploded perspective view of the battery unit shown in FIG. 5.

FIG. 7 is an exploded perspective view of a binding mechanism applicable to the battery pack of FIG. 1.

FIG. 8 is a perspective view of a rear end plate shown in FIG. 7.

FIG. 9 is a diagram illustrating the configuration of an electrode assembly shown in FIG. 5.

### BEST MODE FOR CARRYING OUT THE INVENTION

To solve the technical problems mentioned above and other problems, a battery pack of the present disclosure including multiple battery units arranged along a first axis is provided. Each battery unit includes an electrode assembly, and a case accommodating the electrode assembly, wherein the case has first and second sides facing each other along the first axis, the first side has a movable surface enabling positional movement along the first axis, and the second side has a protruding surface that protrudes in a direction away from the first side along the first axis.

For example, the positional movement of the movable surface may include a movement in a direction of pressing the electrode assembly between the first and second sides.

For example, the battery unit further may include a side connecting the first side to the second side, and the positional movement of the movable surface may include a sliding movement guided along the side.

For example, between adjacent battery units along the first axis, a movable surface in the first side may receive pressure from a protruding surface of a second side of another adjacent battery unit and may move along the first axis.

For example, the movable surface of the first side may move toward the second side of the same battery unit in which the first side is included and presses the electrode assembly between the first and second sides.

For example, the first side further may include a first edge portion surrounding the movable surface on the outer side of the movable surface which is relatively distant from the second side, and the second side may further include a second edge portion surrounding the protruding surface on the inner side of the protruding surface which is relatively close to the first side.

For example, an exposed region of the movable surface exposed from the first edge portion and the protruding surface may be formed at positions corresponding to each other.

For example, the first edge portion may be formed to be stepped from the movable surface toward the outer side away from the second side, and the second edge portion may be formed to be stepped from the protruding surface toward the inner side approaching the first side.

For example, the case may include a can integrally formed from the first edge portion of the first side to a side connecting the first side to the second side and the entire second side.

For example, in the arrangement of multiple battery units arranged along the first axis, the first and second sides may be arranged alternately along the first axis.

For example, in the arrangement of multiple battery units arranged along the first axis, the first and second sides may be placed at one end location and the other end location, respectively, which correspond to the outermost positions along the first axis.

For example, on the outside of the first side at the outermost location along the first axis, a pressure plate having a protruding surface for providing pressure to a movable surface of the first side may be arranged.

For example, the battery pack may further include a binding mechanism that provides a binding force to physically bind the multiple battery units arranged along the first axis.

For example, the binding force provided by the binding mechanism may be transmitted along the first axis in which the multiple battery units are arranged, providing a pressure that induces the positional movement of the movable surface along the first axis in each battery unit.

For example, the binding mechanism includes a pair of end plates including a front end plate and a rear end plate respectively formed outside one end location and the other end location in the first axis, in the arrangement of multiple battery units arranged along the first axis, and a pair of side plates extending across the sides of multiple battery units arranged along the first axis and connecting the front end plate to the rear end plate.

For example, one end plate of the front end plate and the rear end plate may include a protruding surface for providing pressure to the movable surface of the outermost first side along the first axis.

For example, the movable surface may provide elasticity or cushioning between adjacent battery units to absorb swelling of multiple battery units arranged along the first axis.

For example, the movable surface may include an elastic material.

For example, the electrode assembly may include multiple electrode layers stacked along the first axis.

For example, the electrode assembly may include an electrolyte layer between electrode layers of different polarities according to the first axis, and the electrolyte layer may include a solid electrolyte.

For example, the battery pack may further include an alignment mechanism for aligning multiple electrode layers arranged along the first axis.

For example, the alignment mechanism may include guide columns extending along the first axis to pass through corresponding positions of multiple electrode layers arranged along the first axis or corresponding positions of gaskets surrounding the outer circumferences of multiple electrode layers.

For example, the electrode layer may include first and second electrode layers of different polarities.

The guide columns may continuously pass through the gaskets surrounding the outer circumferences of the first electrode layer and the second electrode layer and may align the first electrode layer with the second electrode layer surrounded by the gaskets.

For example, the gasket may include a central opening defining the correct location of the second electrode layer, and an edge surrounding the central opening.

For example, the gasket may include a pair of strips arranged to face each other while extending in a direction of the long side of the second electrode layer, and another pair of strips arranged to face each other while extending in a direction of the short side of the second electrode layer, and through-holes formed at four corner positions where the pair of strips extending in the direction of the long side and another pair of strips extending in the direction of the short side come into contact with each other.

The guide columns continuously pass through through-holes formed at four corner positions of the gaskets and through-holes formed at four corner positions of the second electrode layer.

### MODE FOR THE INVENTION

Hereinafter, with reference to the attached drawings, a battery pack according to an embodiment of the present disclosure may be described.

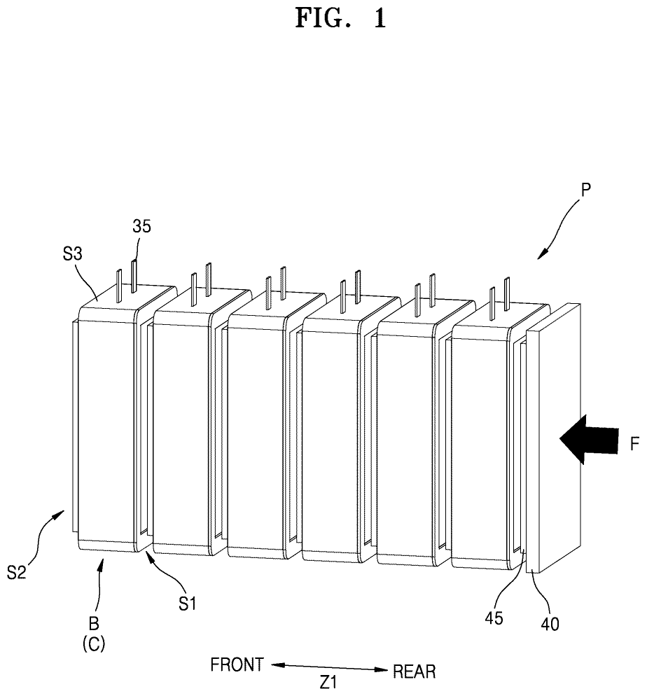

FIG. 1 is a perspective view of a battery pack P according to an embodiment of the present disclosure.

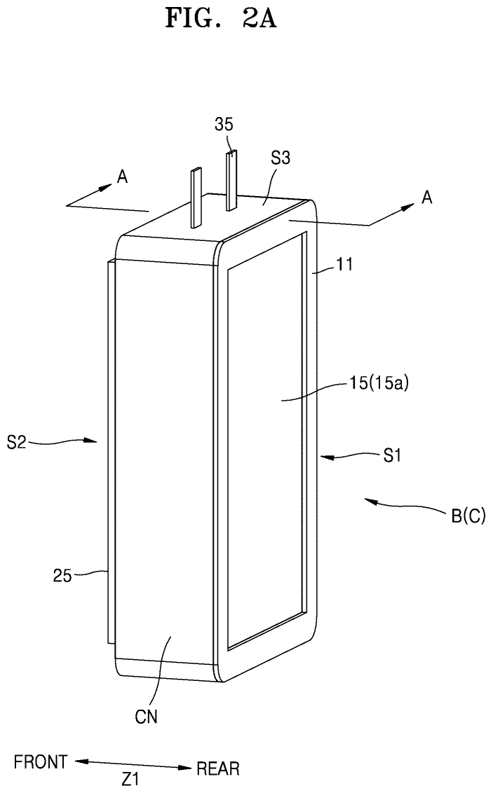

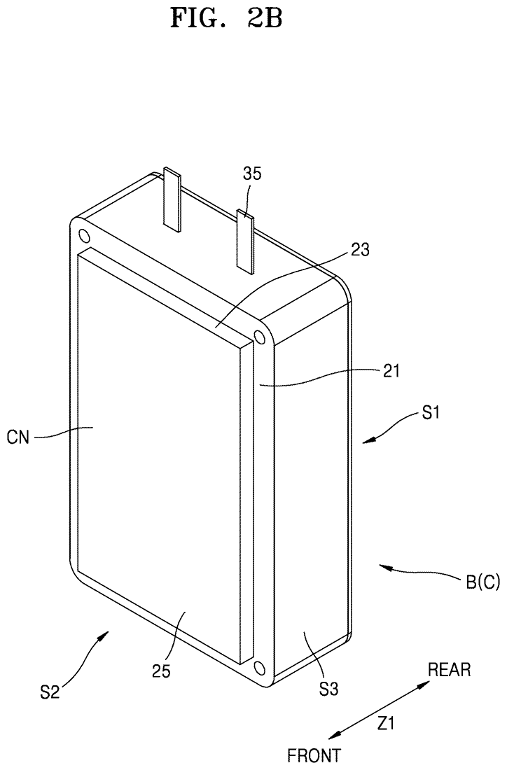

FIGS. 2A and 2B are different perspective views of a first side S1 and a second side S2 of a battery unit B shown in FIG. 1, respectively.

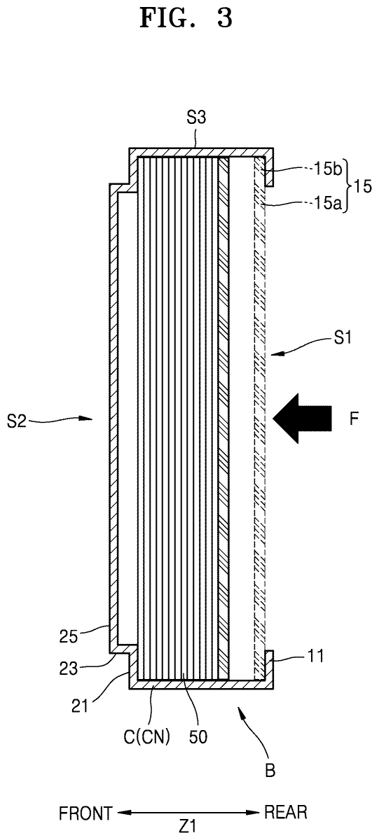

FIG. 3 is a cross-sectional view of the battery unit B, taken along line A-A in FIG. 2A.

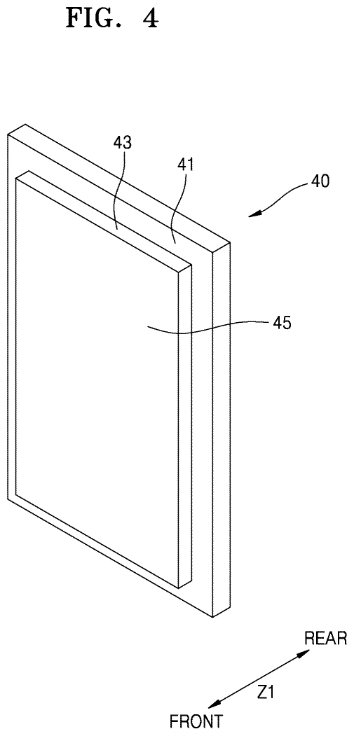

FIG. 4 is a perspective view of a pressure plate 40 shown in FIG. 1.

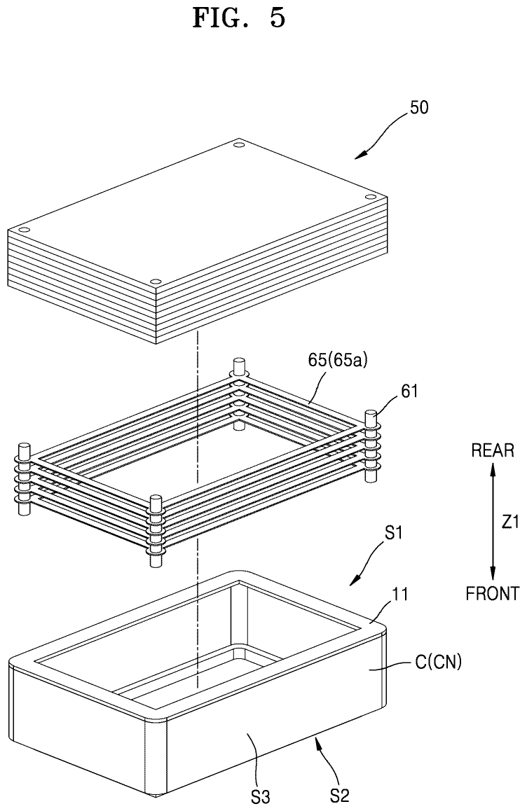

FIG. 5 is an exploded perspective view of the battery unit B shown in FIG. 1.

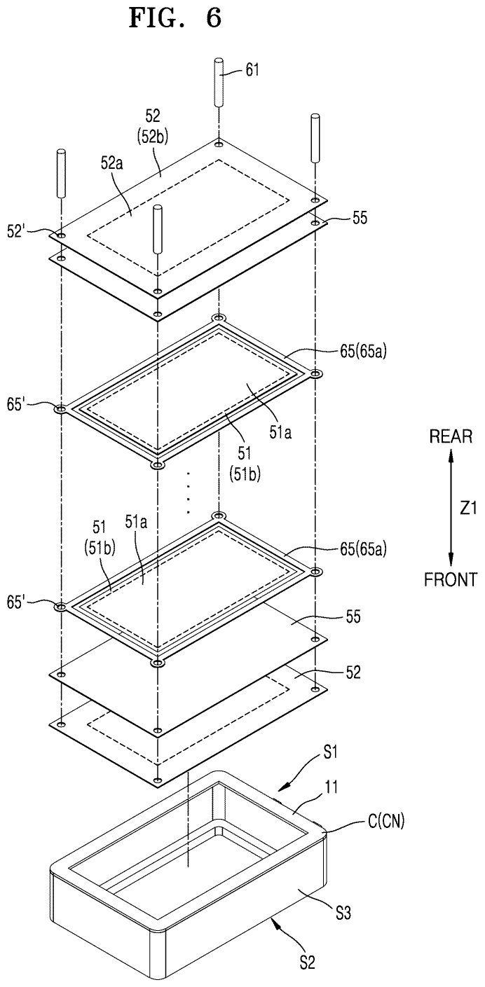

FIG. 6 is another exploded perspective view of the battery unit B shown in FIG. 5.

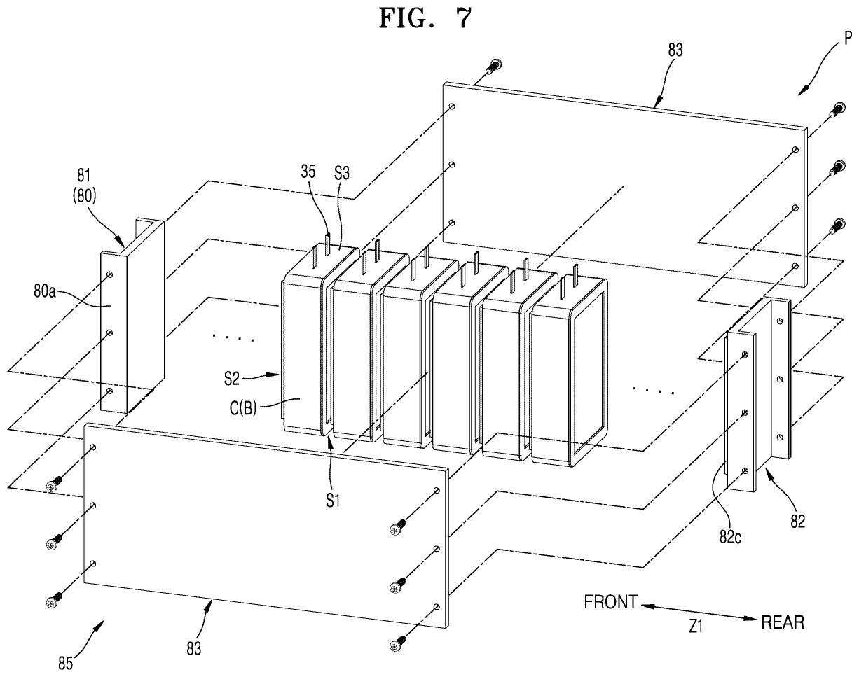

FIG. 7 is an exploded perspective view of a binding mechanism 85 applicable to the battery pack P of FIG. 1.

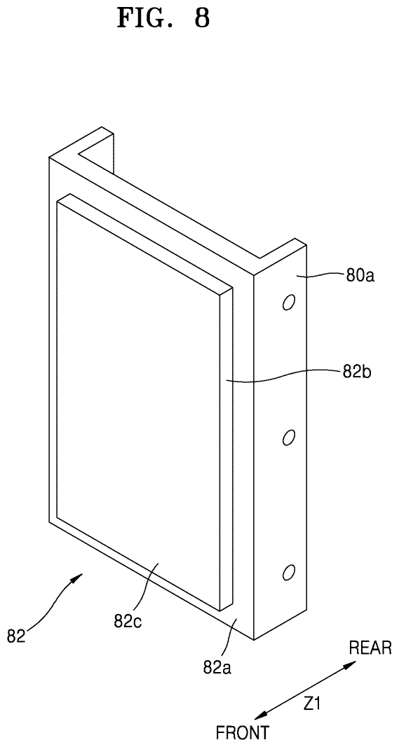

FIG. 8 is a perspective view of a rear end plate 82 shown in FIG. 7.

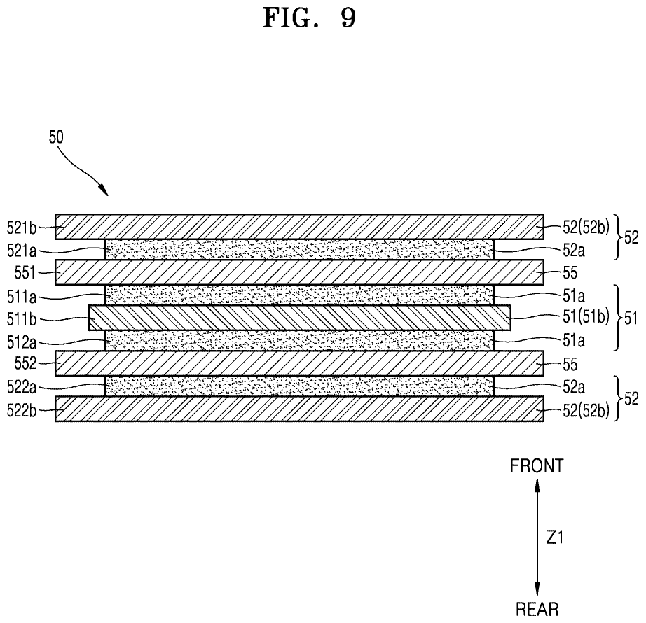

FIG. 9 is a diagram illustrating the configuration of an electrode assembly 50 shown in FIG. 5.

Referring to FIGS. 1 to 3, the battery pack P, according to an embodiment of the present disclosure, may include multiple battery units B arranged in a first axis Z1, wherein each battery unit B may include an electrode assembly 50 and a case C accommodating the electrode assembly 50.

The case C may form the exterior of the battery unit B. Throughout this specification, each side forming the exterior of the case C or the battery unit B, e.g., first and second sides S1 and S2 facing each other in the first axis Z1 corresponding to a direction in which the battery units B are arranged, and a third side S3 connecting the first side S1 to the second side S2, as described below, may be referred to as first and second sides S1 and S2 and a third side S3 of the case C or first and second sides S1 and S2 and a third side S3 of the battery unit B. The technical features of the first and second sides S1 and S2 and the third side S3 may be commonly applied to the first and second sides S1 and S2 and the third side S3 of the case C or the battery unit B. In addition, the first and second sides S1 and S2 may refer to one side and the other side of the battery unit B which face each other in the first axis Z1. The first axis Z1 may correspond to a front-to-rear direction in which multiple battery units B are arranged or a front-to-rear direction in which multiple cases C respectively forming the exteriors of the multiple battery units B are arranged. Throughout the specification, both the front-rear direction in which multiple battery units B are arranged and the front-rear direction in which multiple cases C are arranged may be referred to as the first axis Z1.

The case C may include the first and second sides S1 and S2 facing each other in the first axis Z1 in which multiple battery units B are arranged and may include the third side S3 connecting the first side S1 to the second side S2. In an embodiment of the present disclosure, in each battery unit B, the first and second sides S1 and S2 may refer to one side and the other side facing each other in the first axis Z1. In the battery pack P including the multiple battery units B arranged in the first axis Z1, the first and second sides S1 and S2 of each battery unit B may be oriented in a direction in which the first and second sides S1 and S2 are aligned with each other. For example, among battery units B adjacent to each other in the first axis Z1, a first side S1 of the front battery unit B may be placed adjacent to a second side S2 of the rear battery unit B. For example, by the pressure in the first axis Z1, the first side S1 of the front battery unit B and the second side S2 of the rear battery unit B may exchange pressure while contacting each other.

In an embodiment of the present disclosure, the first side S1 of the front battery unit B may be formed as a pressure receiving side that receives pressure in the first axis Z1 and moves in the first axis Z1. The second side S2 of the rear battery unit B may be formed as a pressure providing side that provides pressure in the first axis Z1. Throughout the specification, the pressure in the first axis Z1 refers to a pressure between the front battery unit B and the rear battery unit B which are adjacent to each other in the first axis Z1. The pressure in the first axis Z1 may refer to a bilateral pressure between the first side S1 and the second side S2 of adjacent battery units B, rather than a pressure exerted unilaterally by one side against the other side. As described below, the first side S1 of the battery unit B may be moved in the first axis Z1 by the pressure in the first axis Z1. The second side S2 of the battery unit B may press the first side S1 of the battery unit B to induce the positional movement thereof in the first axis Z1, rather than being moved by the pressure in the first axis Z1. In this sense, it may be understood that the first and second sides S1 and S2 of the battery unit B form the pressure receiving side that receives pressure in the first axis Z1 and the pressure providing side that provides pressure in the first axis Z1, respectively.

In an embodiment of the present disclosure, for example, the fact that the first side S1 is moved by the pressure of the second side S2 while the first and second sides S1 and S2 form physical interference may be due to physical interference between the first and second sides S1 and S2 of the battery units B adjacent to each other in the first axis Z1. The fact that the electrode assembly 50 between the first and second sides S1 and S2 is pressed by the positional movement of the first side S1 may mean that the electrode assembly 50 between the first and second sides S1 and S2 is pressed as the first and second sides S1 and S2 of the same battery unit B approach each other. As described below, with respect to the first side S1 or a movable surface 15 forming the first side S1 and the second side S2 or a protruding surface 25 forming the second side S2, the battery unit B or the electrode assembly 50 may refer to a battery unit B in which the first side S1 or the second side S2 is included or an electrode assembly 50 positioned between the first and the second sides S1 and S2.

In an embodiment of the present disclosure, the positional movement of the first side S due to the physical interference between the first and second sides S1 and S2 of adjacent battery units B may refer to a sliding movement of the first side S1 of the battery unit B pushed toward the second side S2 thereof by the pressure of the second side S2 of the adjacent battery unit B, forming physical interference. The electrode assembly 50 of the battery unit B may be pressed as the first and second sides S1 and S2 of the battery unit B are forced to approach each other by the positional movement of the first side S1 of the battery unit B. For example, in an embodiment of the present disclosure, the positional movement of the first side S1 may mean that the first side S1 of the battery unit B which corresponds to the pressure receiving side is pushed toward the second side S2 of the battery unit B by the pressure of the second side S2 of the adjacent battery unit B which corresponds to the pressure providing side, thereby pressing the electrode assembly 50 between the first and second sides S1 and S2 of the battery unit B. Throughout the specification, the physical interference between the first and second sides S1 and S2, the first side S1 corresponding to the pressure receiving side, or the second side S2 corresponding to the pressure providing side may refer to first and second sides S1 and S2 of different battery units B adjacent to each other in the first axis Z1. In contrast, the fact that the electrode assembly 50 between the first and second sides S1 and S2 is pressed by the positional movement of the first side S1 may mean that the electrode assembly 50 between the first and second sides S1 and S2 is pressed as the first and second sides S1 and S2 of the battery unit B, in which the first side S1 moved in the first axis Z1, approach each other.

In various embodiments of the present disclosure, the positional movement of the first side S1 may mean that all of the first side S1, among the first and second sides S1 and S2 which form both sides facing each other in the first axis Z1 or opposite to each other in the first axis Z1, moves or slides in the first axis Z1. Alternatively, as described below, the positional movement of the first side S1 may mean that part, but not all, of the first side S1 moves or slides in the first axis Z1. However, in an embodiment of the present disclosure, the positional movement of the first side S1 may be understood as different from the deformation of the first side S1 that does not involve movement or sliding movement of all or part of the first side S1, including the case where the first side S1 is deformed to be convex or concave in the first axis Z1 without movement or sliding movement in the first axis Z1, e.g., the case where the first side S1 is transformed from a flat state to a convex or concave state in the first axis Z1, or conversely, the first side S1 is transformed from a convex or concave state to a flat state in the first axis Z1.

In an embodiment of the present disclosure, the first and second sides S1 and S2 may refer to both sides facing each other in the first axis Z1 in each battery unit B or to both sides opposite to each other in the first axis Z1. In an embodiment of the present disclosure, multiple battery units B arranged in the first axis Z1 may face other adjacent battery units B through first and second sides S1 and S2, which form opposite sides of each battery unit B. In an embodiment of the present disclosure, the first and second sides S1 and S2 may be aligned in a certain orientation through the arrangement of the battery units B in the first axis Z1. For example, the first and second sides S1 and S2 of multiple battery units B may be arranged in the first axis Z1 in an alternating order and may be arranged in the first axis Z1 in an alternating order of the first side S1, the second side S2, the first side S1, and the second side S2. As such, in the arrangement where the first and second sides S1 and S2 are arranged alternately in the first axis Z1, different first and second sides S1 and S2 may be arranged at one end location and the other end location corresponding to the outermost positions, respectively.

The first side S1 may include a movable surface 15 that receives pressure in the first axis Z1 and moves in the first axis Z1. The positional movement of the movable surface 15 in the first axis Z1 may mean that the movable surface 15 is dynamically determined to be moved in the first axis Z1 by physical interference between adjacent battery units B or pressure between adjacent battery units B. In an embodiment of the present disclosure, the movable surface 15 may be configured to move or slide in the first axis Z1. As described below, the movable surface 15 may be moved to be spaced apart from a first edge portion 11 in the first axis Z1. The movable surface 15 may be guided along the third side S3, which connects the first side S1 to the second side S2, while being spaced apart from the first edge portion 11 of the first side S1 and moved toward the second side S2.

The first side S1 may include the movable surface 15 and the first edge portion 11 that surrounds the edge of the movable surface 15 and supports the movable surface 15. In an embodiment of the present disclosure, the positional movement of the movable surface 15 in the first axis Z1 may mean that the movable surface 15 may move or slide in the first axis Z1 to press the electrode assembly 50 therein. For example, the movable surface 15 of the first side S1 of the battery unit B may move toward the second side S2 of the battery unit B to press the electrode assembly 50 therein between the first and second sides S1 and S2 approaching each other.

In an embodiment of the present disclosure, the movable surface 15 may be formed over a large area including the central location of the first side S1. The first edge portion 11 formed over a narrow area corresponding to the edge location of the first side S1 may surround the movable surface 15. The movable surface 15 and the first edge portion 11 may form a stepped surface with respect to each other. For example, the first edge portion 11 may be formed outside the battery unit B rather than the movable surface 15 in the first axis Z1. The first edge portion 11 on the outside of the movable surface 15 in the first axis Z1 may support the movable surface 15 along the edge of the movable surface 15 while functioning as a stopper to prevent the movable surface 15 from being separated from the first side S1. The inside and the outside of the battery unit B may refer to an inside location relatively close to the second side S2 of the battery unit B and an outside location relatively far from the second side S2 of the battery unit B, respectively. For example, the movable surface 15 may be formed at the inside location relatively close to the second side S2 and the first edge portion 11 may surround the movable surface 15 on the outside of the movable surface 15, which is relatively far from the second side S2. More specifically, the first edge portion 11 may be formed to be stepped from the movable surface 15 toward the outside away from the second side S2. The movable surface 15 receives pressure from the second side S2 of another adjacent battery unit B. However, when observed from the battery unit B where the movable surface 15 is included, the movable surface 15 disposed on the inside of the battery unit B relatively close to the second side S2 may be moved toward the inside of the battery unit B.

The movable surface 15 may receive pressure in the first axis Z1 through a portion exposed from the first edge portion 11 and may be moved in the first axis Z1 while being pushed toward the second side S2 of the battery unit B which faces the first side S1 thereof. Accordingly, the movable surface 15 may press the electrode assembly 50 between the first and second sides S1 and S2. In addition, as the movable surface 15 is supported by an edge facing the first edge portion 11, the movable surface 15 may not deviate from the first side S1 beyond the first edge portion 11 in the first axis Z1 even when the pressure in the first axis Z1 is released. For example, in an embodiment of the present disclosure, the movable surface 15 may include an exposed region 15a exposed from the first edge portion 11 and an edge 15b surrounding the exposed region 15a and facing the first edge portion 11. The exposed region 15a of the movable surface 15 of the battery unit B may receive pressure from the second side S2 of another adjacent battery unit B and may be pushed toward the first side S1 of the battery unit B, thereby forming the positional movement in the first axis Z1. The positional movement in the first axis Z1 may be formed by all of the movable surface 15. For example, all of the movable surface 15 which includes the exposed region 15a receiving the pressure of another adjacent battery unit B and the edge 15b surrounding the exposed region 15a may form the positional movement in the first axis Z1. For example, the positional movement of the movable surface 15 in the first axis Z1 may refer to the sliding movement of all of the movable surface 15 in the first axis Z1. For example, in an embodiment of the present disclosure, the positional movement of the first side S1 may be achieved by receiving pressure from the protruding surface 25 of the second side S2 through the exposed region 15a of the first side S1 and sliding the edge of the first side S1 on the third side S3 along the guide of the third side S3 connecting the first side S1 to the second side S2 through the edge 15b surrounding the exposed region 15a of the first side S1.

In an embodiment of the present disclosure, the second side S2 may include the protruding surface 25 that provides pressure in the first axis Z1 for the positional movement of the first side S1 in the first axis Z1, and a second edge portion 21 that surrounds the edge of the protruding surface 25 and supports the protruding surface 25. In an embodiment of the present disclosure, the protruding surface 25 may be formed over a large area including the central location of the second side S2. The second edge portion 21 formed over a narrow area corresponding to the edge location of the second side S2 may surround the movable surface 25.

In an embodiment of the present disclosure, the protruding surface 25 and the second edge portion 21 may form stepped surfaces relative to each other in the first axis Z1. For example, the second edge portion 21 may be formed on the inside of the battery unit B, rather than the protruding surface 25, in the first axis Z1. More specifically, the protruding surface 25 which protrudes toward the outside of the battery unit B to be stepped from the second edge portion 21 through stepped surfaces 23 in contact with the edges of the protruding surface 25 may provide pressure to the first side S1 of another adjacent battery unit B. The inside and the outside of the battery unit B may refer to an inside location relatively close to the first side S1 of the battery unit B and an outside location relatively far from the first side S1 of the battery unit B, respectively. For example, the protruding surface 25 may protrude from the second edge portion 21 at the inside location relatively close to the first side S1 toward the outside away from the first side S1. Conversely, the second edge portion 21 may be formed to be stepped from the protruding surface 25 toward the inside approaching the first side S1. The protruding surface 25 provides pressure to the first side S1 of another adjacent battery unit B. However, when observed from the same battery unit B, the protruding surface 25 may protrude toward the outside of the battery unit B away from the first side S1.

Rather than being formed over the entire second side S2, the protruding surface 25 may protrude in a stepped manner from the second edge portion 21 and may provide pressure locally and intensively to the movable surface 15 exposed from the first edge portion 11. In an embodiment of the present disclosure, the movable surface 15 (corresponding to the exposed region 15a) exposed from the first edge portion 11 and the protruding surface 25 of the second side S2 may be formed at positions and with areas corresponding to each other. The first and second edge portions 11 and 21 surrounding the movable surface 15 (corresponding to the exposed region 15a) exposed from the first edge portion 11 and the protruding surface 25 of the second side S2 formed at positions and with areas corresponding to each other may also be formed at positions and with areas corresponding to each other.

In an embodiment of the present disclosure, the movable surface 15 (corresponding to the exposed region 15a) exposed from the first edge portion 11 and the protruding surface 25 of the second side S2 may be formed substantially at the same location and with the same area over multiple battery units B arranged in the first axis Z1. By forming the multiple battery units B into a standardized, substantially identical shape, the manufacturing process of the battery pack P may be simplified. By forming the physical interference between the movable surface 15 (corresponding to the exposed region 15a) exposed from the first edge portion 11 and the protruding surface 25 of the second side S2 of adjacent battery units B formed at the corresponding positions and with the corresponding areas, the positional movement of the first side S1 may be induced and the positional movement of the first side S1 may be prevented from being blocked despite the pressure between the first and second sides S1 and S2 due to the misalignment between the movable surface 15 exposed from the first edge portion 11 and the protruding surface 25 of the second side S2 of the adjacent battery units B. For example, when the misalignment occurs between the first and second sides S1 and S2, the first edge portion 11 may be positioned between the movable surface 15 (corresponding to the exposed region 15a) exposed from the first edge portion 11 and the protruding surface 25 of the second side S2. Thus, the pressure from the protruding surface 25 of the second side S2 may not be transmitted to the movable surface 15 of the first side S1 and the pressure transmission therebetween may be blocked by the first edge portion 11. For example, in an embodiment of the present disclosure, the movable surface 15 (corresponding to the exposed region 15a) and the protruding surface 25 formed on each of multiple battery units B arranged in the first axis Z1 may be formed to overlap with each other in the first axis Z1.

In an embodiment of the present disclosure, the fact that the protruding surface 25 provides pressure in the first axis Z1 may mean that the second side S2 of the rear battery unit B provides pressure toward the first side S1 of the front battery unit B of adjacent battery units B as the first and second sides S1 and S2 of the front and rear battery units B adjacent to each other are arranged to face each other in the first axis Z1. As the first side S1 of the front battery unit B receives pressure from the second side S2 of the rear battery unit B and is pushed, the location of the first side S1 of the front battery unit B may be moved toward the second side S2 of the front battery unit B. Accordingly, as the first and second sides S1 and S2 of the front battery unit B approach each other, the electrode assembly 50 between the first and second sides S1 and S2 thereof may be pressed. The first side S1 and the second side S2, which are moved in the first axis Z1 by the physical interference therebetween, may form the pressure receiving side of the front battery unit B and the pressure providing side of the rear battery unit B, respectively, which are adjacent to each other.

In an embodiment of the present disclosure, the pressure receiving side of the first side S1 may refer to the movable surface 15 that can be moved in the first axis Z1, rather than all of the first side S1 of the front battery unit B. For example, the first edge portion 11 surrounding the movable surface 15 may not be moved in the first axis Z1. Similarly, the pressure providing side may refer to the protruding surface 25 of the second side S2 that can form physical interference with the movable surface 15 of the first side S1, rather than all of the second side S2 of the rear battery unit B. For example, the second edge portion 21 surrounding the protruding surface 25 may not provide pressure toward the movable surface 15 of the first side S1.

In an embodiment of the present disclosure, through the configuration in which the movable surface 15 of the first side S1 and the protruding surface 25 of the second side S2 are arranged adjacent to each other to form physical interference between adjacent battery units B in the first axis Z1, the movable surface 15 of the first side S1, pressed from the protruding surface 25 of the second side S2, may be pushed toward the second side S2 of the battery unit B, thereby pressing the electrode assembly 50 of the battery unit B between the first and second sides S1 and S2. The multiple battery units B arranged between the frontmost battery unit B and the rearmost battery unit B in the first axis Z1 may form physical interference between the movable surface 15 of the first side S1 and the protruding surface 25 of the second side S2 of adjacent battery units B. However, either the frontmost battery unit B or the rearmost battery unit B may not form physical interference between the movable surface 15 of the first side S1 and the protruding surface 25 of the second side S2 due to the absence of another battery unit B adjacent thereto. According to an embodiment of the present disclosure, in multiple battery units B arranged in the first axis Z1, the first side S1 forming the pressure receiving side and the second side S2 forming the pressure providing side may be arranged alternately in the first axis Z1. From the second side S2 of the frontmost battery unit B to the first side S1 of the rearmost battery unit B which form both ends in the first axis Z1, the first and second sides S1 and S2 may be arranged alternately in the first axis Z1. The second side S2 of the frontmost battery unit B may include the protruding surface 25 as multiple battery units B arranged in the first axis Z1 are formed into a standardized and substantially identical shape. However, due to the absence of another adjacent battery unit B, the second side S2 of the frontmost battery unit B may not function as a pressure providing side that forms the physical interference with the first side S1 of another adjacent battery unit B. As such, although the second side S2 of the frontmost battery unit B does not function as the pressure providing side, the first side S1 of the frontmost battery unit B may be pushed toward the second side S2 thereof by the physical interference with the adjacent rear battery unit B. The electrode assembly 50 between the first and second sides S1 and S2 may be pressed by the positional movement of the first side S1 in a direction in which the first and second sides S1 and S2 approach each other.

As such, the second side S2 (or the protruding surface 25 of the second side S2) of the frontmost battery unit B, which forms one end in the first axis Z1, may not function as the pressure providing side due to the absence of another adjacent battery unit B. Similarly, the first side S1 (or the movable surface 15 of the first side S1) of the rearmost battery unit B, which forms the other end in the first axis Z1, may not function as the pressure receiving side due to the absence of another adjacent battery unit B. Accordingly, the first side S1 of the rearmost battery unit B may not be moved toward the second side S2, and thus may not press the electrode assembly 50 between the first and second sides S1 and S2. For example, although the second side S2 of the frontmost battery unit B does not function as the pressure providing side, the electrode assembly 50 thereof may be pressed by the first side S1 approaching towards the second side S2 through physical interference with the adjacent rear battery unit B. However, the rearmost battery unit B may not induce the positional movement of the first side S1. Thus, in an embodiment of the present disclosure, a separate pressure plate 40 including a protruding surface 45 may be placed outside the rearmost battery unit B to be adjacent to the rearmost battery unit B.

In an embodiment of the present disclosure, the pressure plate 40 may be placed on the outermost first side S1 (e.g., first side S1 of the rearmost battery unit B), unable to function as the pressure receiving side and thus unable to induce positional movement of the first side S, and may not be placed on the outermost second side S2 (second side S2 of the frontmost battery unit B). For example, in the arrangement of the first and second sides S1 and S2 alternately arranged in the first axis Z1, the pressure plate 40 may not be arranged on the outermost second side S2 forming one end in the first axis Z1 and may be selectively placed on the outermost first side S1 forming the other end in the first axis Z1. In an embodiment of the present disclosure, the second side S2 is placed at the frontmost location and the first side S1 is placed at the rearmost location in the first axis Z1. In various embodiments of the present disclosure, e.g., in the arrangement of the first and second sides S1 and S2 arranged in the opposite orientation to the embodiment of the present disclosure, the first side S1 may be placed at the frontmost location and the second side S2 may be placed at the rearmost location in the first axis Z1. In these embodiments, the pressure plate 40 may be placed at the frontmost location rather than the rearmost location. More specifically, the pressure plate 40 may be placed outside the frontmost battery unit B.

Throughout the specification, the outermost first side S1 may refer to a first side S1 at the outermost location of the multiple battery units B arranged in the first axis Z1. The outermost second side S2 may refer to a second side S2 at the outermost location of the multiple battery units B arranged in the first axis Z1. For example, in an embodiment of the present disclosure, the fact that the pressure plate 40 is placed adjacent to the outermost first side S1 may mean that the pressure plate 40 is placed adjacent to the battery unit B including the outermost first side S1 among multiple battery units B arranged in the first axis Z1. For example, this may mean that the pressure plate 40 may be placed at the rear corresponding to the outside of the rearmost battery unit B or at the front corresponding to the outside of the frontmost battery unit B.

The pressure plate 40 may be formed to correspond to the outermost first side S1 (the first side S1 of the rearmost battery unit B), forming the physical interference therebetween. The protruding surface 45 of the pressure plate 40 may be formed at the location and with the area corresponding to the movable surface 15 (corresponding to the exposed region 15a) of the outermost first side S1. For example, the protruding surface 45 of the pressure plate 40 may be formed at the location and with the area corresponding to the movable surface 15 (corresponding to the exposed region 15a) of the first side S1 of the rearmost battery unit B, which corresponds to the outermost first side S1. In other words, the protruding surface 45 of the pressure plate 40 may be formed at the location and with the area corresponding to the movable surfaces 15 (corresponding to the exposed regions 15a) of multiple battery units B arranged in the first axis Z1 and formed in a standardized substantially identical shape. For example, the movable surface 15 (corresponding to the exposed region 15a) and the protruding surface 25 of the battery units B arranged in the first axis Z1 may be formed to overlap with the protruding surface 45 of the pressure plate 40 in the first axis Z1. For example, in an embodiment of the present disclosure, the movable surface 15 (corresponding to exposed region 15a) of the first side S1 and the protruding surface 25 of the second side S2, which form the physical interference with each other, and the protruding surface 45 of the pressure plate 40 may all be formed at corresponding locations and with corresponding areas.

As such, the protruding surface 45 of the pressure plate 40 may be formed at the location corresponding to the movable surface 15 (corresponding to the exposed region 15a) of the outermost first side S1. For example, the protruding surface 45 of the pressure plate 40 may be formed over a large area including the central location of the pressure plate 40, may protrude in a stepped manner from the edge portion 41 through the stepped surfaces 43 in contact with the edges of the protruding surface 45, and may protrude toward the outermost first side S1.

Referring to FIGS. 1 to 3 and FIG. 7 together, the battery pack P according to an embodiment of the present disclosure may include a binding mechanism 85 for binding multiple battery units B arranged in the first axis Z1 into one pack. In an embodiment of the present disclosure, the binding mechanism 85 may provide a binding force to physically bind the multiple battery units B arranged in the first axis Z1. In addition, in the arrangement of multiple battery units B in which the first and second sides S1 and S2 are alternatively arranged in the first axis Z1 to form the physical interference between the first side S1 including the movable surface 15 and the second side S2 including the protruding surface 25, the binding force may be transmitted in the first axis Z1 where the multiple battery units B are arranged and may function as a pressure that causes the positional movement of the first side S1 in each battery unit B. Through the positional movement of the first side S1 in each battery unit B, the electrode assembly 50 of each battery unit B may be pressed.

In an embodiment of the present disclosure, the bonding force that binds multiple battery units B arranged in the first axis Z1 may be transmitted in the first axis Z1 and may function as a pressure between the movable surface 15 and the protruding surface 25 of the first and second sides S1 and S2 of adjacent battery units B. The pressure between the movable surface 15 and the protruding surface 25 of the first and second sides S1 and S2 may induce the positional movement of the first side S1 in each battery unit B. In each battery unit B, the electrode assembly 50 between the first and second sides S1 and S2 may be pressed as the first and second sides S1 and S2 approach each other. As such, the bonding force that binds the multiple battery units B arranged in the first axis Z1 may function as a pressure between the movable surface 15 and the protruding surface 25 of the first and second sides S1 and S2 adjacent to each other in the first axis Z1 and may function as a pressure on the electrode assembly 50 forming the interior of each battery unit B.

In an embodiment of the present disclosure, the binding mechanism 85 may be modified in various ways to the extent that the binding mechanism 85 provides a binding force in a compression direction for multiple battery units B in the first axis Z1 while surrounding the outer circumference of the multiple battery units B arranged in the first axis Z1. For example, the binding mechanism 85 may be provided in the form of a band that continuously surrounds the outer circumference of the multiple battery units B arranged in the first axis Z1 or may be provided in the form of multiple connected plates arranged along the outer circumference of the multiple battery units B arranged in the first axis Z1. Alternatively, the binding mechanism 85 may be provided in the form of a band that surrounds the multiple battery units B while extending along the outer circumference of one or more plates arranged along the outer circumference of the multiple battery units B or two or more plates spaced apart from each other along the outer circumference of the multiple battery units B, wherein the multiple plates arranged along the outer circumference of the multiple battery units B arranged in the first axis Z1 are not connected to each other. In an embodiment of the present disclosure, the band or plate forming the binding mechanism 85 may include any material, such as a metal band, an elastic band, a metal plate, and a resin plate.

In an embodiment of the present disclosure shown in FIG. 7, the binding mechanism 85 may include multiple plates 81, 82, and 83 coupled to each other along the outer circumference of the multiple battery units B to surround the outer circumference of the multiple battery units B arranged in the first axis Z1. For example, in the arrangement of multiple battery units B arranged in the first axis Z1, the binding mechanism 85 may include a pair of end plates 80 including a front end plate 81 and a rear end plate 82 arranged on the outside of the frontmost battery unit B and on the outside of the rearmost battery unit B, respectively, and forming an end location and the other end location, and a pair of side plates 83 extending across the third side S3 of the multiple battery units B in the first axis Z1 and connecting the front end plate 81 to the rear end plate 82.

Referring to FIG. 7, the pressure plate 82 may be arranged adjacent to the outermost first side S1 in the first axis Z1. The pressure plate 82 may function as the rear end plate 82 and form the binding mechanism 85 for binding multiple battery units B arranged in the first axis Z1. That is, in an embodiment of the present disclosure, the pressure plate 82 and the rear end plate 82 may be implemented as the same component. The same drawing numbers are assigned to the pressure plate 82 and the rear end plate 82 in the drawings attached to this specification.

Referring to FIG. 8, the rear end plate 82 may include a protruding surface 82c to provide a pressure to the movable surface 15 formed on the outermost first side S1 (the first side S1 of the rearmost battery unit B) and may include an edge portion 82a supporting the protruding surface 82c at a stepped location from the protruding surface 82c, and stepped surfaces 82b between the protruding surface 82c and the edge portion 82a. As such, in an embodiment of the present disclosure, the rear end plate 82 may include the protruding surface 82c. In contrast, the front end plate 81 may not include a protruding surface or a movable surface and, for example, may be formed flat. In various embodiments of the present disclosure, the end plate 80 (rear end plate 82), which performs the function of the pressure plate 82 may correspond to an end plate 80 (rear end plate 82) adjacent to the outermost first side S1, among the front end plate 81 and the rear end plate 82 arranged at the front and at the rear in the first axis Z1.

In an embodiment shown in FIG. 7, the pressure plate 82 adjacent to the outermost first side S1 and the end plate 80 (rear end plate 82) disposed on the outside of an end location or the other end location in the first axis Z1 may be formed as a single complex component. The function of the pressure providing side to form physical interference with the outermost first side S1 (function of pressure plate 82) and the function of binding the multiple battery units B into one pack (function of rear end plate 82) may be exerted through the single complex component. However, in various embodiments of the present disclosure, the pressure plate 82 and the end plate 80 (rear end plate 82) may be provided as different separable components. For example, the pressure plate 82 may be arranged on the outside of the outermost first side S1 to be adjacent to the outermost first side S1 and the separate end plate 80 (rear end plate 82) may be arranged on the outside of the pressure plate 82. For example, in various embodiments of the present disclosure, the pressure plate 82 may be placed behind the rearmost battery unit B, and the separate end plate 80 (rear end plate 82) may be placed behind the pressure plate 82. The rear end plate 82 and the front end plate 81 may be formed to have substantially the same shape. As such, by forming the front end plate 81 and the rear end plate 82, which are arranged outside the end location and the other end location in the first axis Z1, to have substantially the same shape, convenience in manufacturing the battery pack P may be improved. For example, the battery pack P may be easily assembled without distinguishing the front end plate 81 from the rear end plate 82.

In an embodiment of the present disclosure, the end plates 80 and side plates 83 may be connected together to surround the outer circumference of the multiple battery units B arranged in the first axis Z1. The end plates 80 and the side plates 83 may contact each other at corner positions of the arrangement of the battery units B in the first axis Z1 to form coupling portions to each other. For example, the coupling portions may be formed by aligning fastening holes formed in the flange 80a of the end plate 80 with fastening holes formed at the end of the side plate 83 and inserting fastening members into the fastening holes.

Hereinafter, the configuration of each battery unit B in the battery pack P, according to an embodiment of the present disclosure, may be described.

Referring to FIGS. 1 to 3, the battery unit B may include the first and second sides S1 and S2 arranged on both sides facing each other or both sides opposite each other in the first axis Z1, and a third side connecting the first side S1 to the second side S2. In an embodiment of the present disclosure, the third side S3 connecting the first side S1 to the second side S2 may form a guide surface that guides the positional movement of the first side S1. For example, in an embodiment of the present disclosure, the positional movement of the first side S1 may be guided through the third side S3 which connects the first side S1 to the second side S2. As the first side S1 and the second side S2 sliding along the third side S3 approach each other, the electrode assembly 50 between the first and second sides S1 and S2 may be pressed. That is, in an embodiment of the present disclosure, the positional movement of the first side S1 or the sliding movement of the movable surface 15 that forms positional movement of the first side S1 may be performed from the first side S1 toward the second side S2. This positional movement of the first side S1 may be guided along the third side S3 which connects the first side S1 to the second side S2.

For example, unlike the present disclosure, the deformation of the first side S1 that does not involve movement or sliding movement of the first side S1, including the case where the first side S1 is transformed from a flat state to a convex or concave state in the first axis Z1, or conversely, the first side S1 is transformed from a convex or concave state to a flat state in the first axis Z1, is different from the positional movement of the first side S1 from the first side S1 to the second side S2. The deformation of the first side S1 may be understood as different from the positional movement of the first side S1 in that the deformation of the first side S1 does not involve movement or sliding movement of the first side S1 guided along the third side S3 which connects the first side S1 to the second side S2. For example, unlike the present disclosure, although the deformation of the first side S1 which does not involve the movement or the sliding movement in the first axis Z1 induces compression of the electrode assembly 50 inside the battery unit B by pressing the battery unit B in the first axis Z1, the deformation of the first side S1 may be understood as different from the positional movement of the first side S1 in an embodiment of the present disclosure.

The first and second sides S1 and S2 of the battery unit B may form main surfaces facing each other between adjacent battery units B arranged in the first axis Z1. For example, in an embodiment of the present disclosure, the battery units B adjacent to each other in the first axis Z1 may be arranged to face each other through the first and second sides S1 and S2. The first and second sides S1 and S2 may be arranged in face-to-face contact with each other to form physical interference. In an embodiment of the present disclosure, assuming that the battery unit B has an approximately rectangular shape including a pair of long sides and a pair of short sides, the first and second sides S1 and S2 each may correspond to the main surface occupying a relatively large area. The third side S3 may include a pair of short sides and a pair of long sides surrounding the outer circumference of the battery unit B along the edges of the first and second sides S1 and S2 and may be formed as a relatively narrow surface surrounding the outer circumference of the battery unit B between the first and second sides S1 and S2.

On the third side S3 of the battery unit B, electrode tabs 35 electrically connected to the electrode assembly 50 may be formed. The electrode tabs 35 may be electrically connected to electrode layers (anode layer 51 and cathode layer 52) having different polarities of the electrode assembly 50, respectively. For example, in an embodiment of the present disclosure, the electrode tabs 35 may be formed on the short side rather than the long side of the third side S3 formed along the outer circumference of the battery unit B. For example, the electrode tabs 35 may be formed together on the same short side of the battery unit B.

Referring to FIG. 9, in an embodiment of the present disclosure, the electrode assembly 50 may be formed in a bipolar stack structure. For example, among the anode layers 51 and cathode layers 52 arranged alternately in the first axis Z1, at least one anode layer 51 may face the cathode layers 52 on both sides to function as two sides. Among the anode layers 51 and the cathode layers 52 arranged alternately in the first axis Z1, at least one cathode layer 52 may face the anode layer 51 on one side to function as one side. However, in various embodiments of the present disclosure, among the anode layers 51 and cathode layers 52 arranged alternately in the first axis Z1, at least one cathode layer 52 may face the anode layers 51 on both sides to function as two sides. Among the anode layers 51 and cathode layers 52 arranged alternately in the first axis Z1, at least one anode layer 51 may face cathode layer 52 on one side to function as one side.

More specifically, the electrode assembly 50 may include a bi-cell including a first cathode current collector 521b, a first cathode active material layer 521a, a first electrolyte layer 551, a first anode active material layer 511a, a first anode current collector 511b, a second anode active material layer 512a, a second electrolyte layer 552, a second cathode active material layer 522a, and a second cathode current collector 522b in the first axis Z1. For example, the electrode assembly 50 may include a structure in which multiple bi-cells having the above structure are stacked in the first axis Z1. For example, according to an embodiment of the present disclosure, the electrode assembly 50 may include a structure in which multiple electrode layers are stacked, allowing the capacity and voltage of the battery unit B to be adaptively designed according to the required capacity and voltage. For example, compared to an electrode assembly 50 which has a monopolar structure including the cathode layer 52, the electrolyte layer 55, and the anode layer 51, the electrode assembly 50 may provide high capacity and high output at high voltage.

In an embodiment of the present disclosure, the electrode assembly 50 may be formed in a bipolar stack structure. For example, the cathode layer 52 including the first cathode current collector 521b and first cathode active material layer 521a may function as one side by facing the anode layer 51 including the first and second anode active material layers 511a and 512a and the first anode current collector 511b. The anode layers 51 may function as two sides by facing the cathode layer 52 including the first cathode current collector 521b and the first cathode active material layer 521a and another cathode layer 52 including the second cathode current collector 522b and the second cathode active material 522a on both sides.

Referring to FIGS. 5 and 6, the electrode assembly 50 in the bipolar stack structure in which multiple electrode layers are stacked, according to an embodiment of the present disclosure, may include an alignment structure for the positional alignment of the multiple electrode layers. In an embodiment of the present disclosure, the alignment structure may include multiple electrode layers arranged in the first axis Z1 or guide columns 61 extending in the first axis Z1 to continuously pass through corresponding positions in expanded areas including the outer circumferences of multiple electrode layers.

In an embodiment of the present disclosure, the anode layers 51 and cathode layers 52, which form multiple electrode layers arranged in the first axis Z1, may be formed with different areas. For example, the cathode layers 52 may be formed with a larger area than the anode layers 51. The guide columns 61 may align the anode layers 51 with the cathode layers 52 in the first axis Z1 while passing through the corresponding positions of gaskets 65 surrounding the outer circumferences of the cathode layers 52 and the anode layers 51. In an embodiment of the present disclosure, the cathode layers 52 and the anode layers 51 may be alternately arranged at alternating positions in the first axis Z1. The gaskets 65 surrounding the outer circumferences of the cathode layers 52 and anode layers 51 may also be arranged alternately in the first axis Z1. By continuously passing through the corresponding positions of the gaskets 65 surrounding the outer circumferences of the cathode layers 52 and the anode layers 51 to align the cathode layers 52 with the gasket 65, the guide columns 61 may align the cathode layers 52 with the gaskets 65 or the anode layers 51 surrounded by the gaskets 65 with the gaskets 65.

In an embodiment of the present disclosure, the gasket 65 may include a central opening where the anode layer 51 is placed, and an edge surrounding the central opening. In an embodiment of the present disclosure, the electrode layer forming the electrode assembly 50 may be formed in an approximately rectangular shape including a pair of long sides and a pair of short sides. The gasket 65 may include a pair of strips 65a arranged to face each other while extending in a direction of the long side of the anode layer 51 and another pair of strips 65a arranged to face each other while extending in a direction of the short side the anode layer 51. The guide columns 61 may be inserted into the through-holes formed at corner positions where the pair of strips 65a extending in the direction of the long side and another pair of strips 65a extending in the direction of the short side come into contact with each other. The multiple gaskets 65 arranged in the first axis Z1 may be aligned with each other through the through-holes into which the guide columns 61 are inserted at the four corner positions. The positions of multiple anode layers 51 arranged in the first axis Z1 may be aligned by defining the correct location of the anode layers 51 through the central opening formed when the pair of strips 65a extending in the direction of the long side and another pair of strips 65a extending in the direction of the short side come into contact with each other. The guide columns 61, together with the gaskets 65 surrounding the outer circumference of the anode layers 51, continuously pass through the corresponding positions of the cathode layers 52 arranged alternately with the gaskets 65 or the anode layers 51 in the first axis Z1 and may align the gaskets 65 or the anode layers 51 surrounded by the gaskets 65 with the cathode layers 52.

In various embodiments of the present disclosure, depending on the size relationship between the anode layer 51 and cathode layer 52 forming the electrode layer, the guide columns 61 may continuously pass through corresponding positions of the cathode layers 52 and the gaskets 65 surrounding the outer circumference of the anode layers 51, as shown in FIG. 6. Alternatively, the guide columns 61 may continuously pass through the corresponding positions of the anode layers 51 and the cathode layers 52 without the gaskets 65 and may also continuously pass through the corresponding positions of the gaskets 65 surrounding the outer circumferences of the anode layers 51 and the cathode layers 52.

In an embodiment of the present disclosure shown in FIG. 6, the guide columns 61 may be formed to sequentially pass through the gaskets 652 surrounding the outer circumferences of the anode layers 51 and the cathode layers 52, which are arranged alternately in the first axis Z1. To this end, through-holes for the guide columns 61 may be formed in the gaskets 65 and cathode layers 52. In an embodiment of the present disclosure, the through-holes may be formed at corresponding positions of the gaskets 65 and the cathode layers 52. For example, the through-holes may be formed at four corner positions of the gaskets 65 and may be formed at four corner positions of the negative electrode current collector 52b from which the cathode active material layer 52a is excluded from the cathode layer 52. In an embodiment of the present disclosure, the guide columns 61 may pass through the gaskets 65 and the cathode layers 52 at corresponding positions. For example, the guide columns 61 may pass through the location of the gasket 65 outside the anode current collector 51b where the anode active material layer 51a is formed and may pass through the location inside the negative electrode current collector 52b.

In various embodiments of the present disclosure, the guide columns 61 may only pass through gaskets 65 surrounding the outer circumferences of the anode layers 51 and through-holes for the guide columns 61 may not be formed in the cathode layers 52. That is, in such embodiments, the through-holes for the guide columns 61 may not be formed in the electrode layer including the cathode layers 52 and anode layers 51. The positions of the guide columns 61 may be aligned through the through-holes formed in the gaskets 65 surrounding the outer circumferences of the anode layers 51.

For example, in various embodiments of the present disclosure, the electrode layer may include first and second electrode layers of different polarities. The guide columns 61 may continuously pass through the gaskets 65 surrounding the outer circumferences of the first electrode layer and the second electrode layer and align the first electrode layer with the second electrode layer surrounded by the gaskets 65. Depending on the size relationship between the cathode layer 52 and anode layer 51, the first and second electrode layers may correspond to the cathode layer 52 and the anode layer 51, respectively, or conversely, the first and second electrode layers may correspond to the anode layer 51 and the cathode layer 52, respectively. In the detailed description of the guide columns 61 and gasket 65 forming the previously-described alignment mechanism, the first and second electrode layers may correspond to the cathode layer 52 and the anode layer 51, respectively, or may correspond to the anode layer 51 and the cathode layer 52, respectively. Redundant description of the first and second electrode layers, and the guide columns 61 and gaskets 65 as the alignment mechanism for the positional alignment between the first and second electrode layers may be omitted.

In an embodiment of the present disclosure, the electrode assembly 50 may be formed in a bipolar stack structure in which multiple electrode layers are stacked and may provide the battery units B with relatively high output, compared to the electrode assembly 50 of the monopolar structure. Compared to the electrode assembly 50 with the monopolar structure, the strict process control may be required to prevent tearing of the case C due to the increased thickness in the first axis Z1. In addition, as the swelling increases due to the increased thickness, the output characteristics of the battery may be significantly deteriorated due to poor contact (e.g., poor contact due to uneven contact pressure) between the electrolyte layer 55 including the solid electrolyte and the electrode layer (anode layer 51 and cathode layer 52).

In an embodiment of the present disclosure, with the case C including a can CN which has relatively excellent mechanical strength, tearing of edges of the pouch-type case C due to the increase in the depth of deep drawing to accommodate the relatively thick electrode assembly 50 may be prevented. For example, in an embodiment of the present disclosure, the case C may include the can CN in which the other portions are integrally formed than the movable surface 15 which is moved in the first axis Z1. More specifically, the case C may include the can CN in which the other portions, including the first edge portion 11 of the first side S1, the third side S3, and the second side S2, than the movable surface 15 are integrally formed. In an embodiment of the present disclosure, the can CN, in which the other portions of the case C than the movable surface 15 are integrally formed, has relatively excellent rigidity by using a relatively thick metal plate rather than a thin metal plate, like a pouch. The can CN with high rigidity may effectively suppress swelling of the battery unit B that occurs in the first axis Z1 and may effectively block swelling that propagates cumulatively, especially in the first axis Z1.

Referring to FIGS. 1 to 3, in an embodiment of the present disclosure, the movable surface 15 may be formed to provide elasticity or cushioning between the battery units B adjacent to each other in the first axis Z1 to absorb the volume change in the first axis Z1 by buffering the swelling of the battery units B in the first axis Z1, and to absorb the swelling that propagates cumulatively in the first axis Z1. For example, in an embodiment of the present disclosure, the movable surface 15 may include an elastic material. The movable surface 15 including the elastic material may exhibit excellent sealing properties with the other portions of the case C, for example, the first edge portion 11, which is formed of the can CN. In various embodiments of the present disclosure, the movable surface 15 may include a rubber material or a metal material. The movable surface 15 may be formed in a shape to provide appropriate elasticity or cushioning to absorb swelling, e.g., a mesh or a network structure including multiple two-dimensional or three-dimensional pores, or a shape that is flexible and deformable like a spring. In various embodiments of the present disclosure, the movable surface 15 may include one or more members to provide appropriate elasticity or cushioning in the first axis Z1. For example, the movable surface 15 may be formed by superimposing two or more different members on each other and may also be formed by adding elastic means, such as a separate spring member, to exert elasticity in the first axis Z1. As such, in an embodiment of the present disclosure, the first side S1 (more specifically, the movable surface 15) may function as a spacer to buffer physical interference and absorb swelling between adjacent battery units B by providing elasticity or cushioning therebetween and block the electrical interference between adjacent battery units B using an insulating elastic material.

Referring to FIG. 9, in an embodiment of the present disclosure, the electrode assembly 50 may include a solid electrolyte. Due to the characteristics of the solid electrolyte with relatively poor fluidity, the electrolyte layer 55 including the solid electrolyte may be advantageous for the output characteristics of the battery units B when pressed with the adjacent electrode layers (anode layer 51 and cathode layer 52) at a relatively high contact pressure. Accordingly, in an embodiment of the present disclosure, as the binding force provided during the assembly process of the battery pack P induces the positional movement of the first side S1, and accordingly, the electrode assembly 50 of each battery unit B arranged in the first axis Z1 is pressed at a high pressure, swelling that may increase with an increase in thickness may be effectively suppressed in the electrode assembly 50 in a bipolar stack structure including a relatively large number of electrode layers. For example, the deterioration of the output of the battery units B due to swelling or pressure unevenness between the electrolyte layer 55 including the solid electrolyte and the electrode layer (anode layer 51 and cathode layer 52) caused by swelling may be prevented.

Referring to FIGS. 1 to 3, in an embodiment of the present disclosure, by inducing the sliding movement of the first side S1 through the physical interference between adjacent battery units B and pressing the electrode assembly 50 between the first and second sides S1 and S2 according to the positional movement of the first side S1, the battery units B may be pressed more effectively, compared to the pressing method that does not involve dynamic movement of the case C and may suppress swelling that may occur during charging and discharging of the battery units B with the preset high pressure. In particular, the battery units B including the solid electrolyte may prevent the output of the battery units B from being deteriorated due to swelling of the electrode assembly 50. For example, in an embodiment of the present disclosure, the uniform pressure may be induced through face-to-face contact between adjacent first and second sides S1 and S2. Through the sliding movement of the first side S1, the electrode assembly 50 between the first and second sides S1 and S2 may be pressed with the uniform pressure. For example, unlike the present disclosure, in the method of pressing the case C without involving dynamic movement of the case C, pressure unevenness may be caused at the relatively angled corners and central location of the case C. Accordingly, due to the uneven pressure depending on the location of the electrode assembly 50, the contact pressure between the electrolyte layer 55 including the solid electrolyte and the adjacent electrode layers (anode layer 51 and cathode layer 52) may vary, thereby deteriorating the output characteristics.

In an embodiment of the present disclosure, although the electrode assembly 50 induces the positional movement of the first side S1 through physical interference between adjacent battery units B by using the solid electrolyte with lower fluidity than a liquid or gel electrolyte, there may be a less risk of electrolyte leakage due to the positional movement of the first side S1. For example, the electrolyte leakage may be prevented through sealing (e.g., sealing through the movable surface 15 including an elastic material) between the movable surface 15 which forms the positional movement of the first side S1 and the first edge portion 11 surrounding the movable surface 15.

The present disclosure has been explained with reference to the embodiments shown with reference to the attached drawings, but this is merely an example. A person skilled in the art to which the present disclosure pertains may understand that various modifications and other equivalent embodiments are possible.

### INDUSTRIAL APPLICABILITY

The present disclosure is applicable to a battery pack or a power supply for set devices, such as electronic devices or electric vehicles.

1. A battery pack comprising multiple battery units arranged along a first axis, wherein each battery unit comprises:
an electrode assembly; and
a case accommodating the electrode assembly,
wherein the case has first and second sides facing each other along the first axis,
wherein the first side has a movable surface enabling positional movement along the first axis, and the second side has a protruding surface that protrudes in a direction away from the first side along the first axis.

2. The battery pack of claim 1, wherein the positional movement of the movable surface comprises a movement in a direction of pressing the electrode assembly between the first and second sides.

3. The battery pack of claim 1, wherein the battery unit further comprises a side connecting the first side to the second side, and
the positional movement of the movable surface comprises a sliding movement guided along the side.

4. The battery pack of claim 1, wherein, between adjacent battery units according to the first axis, a movable surface in the first side receives pressure from a protruding surface of a second side of another adjacent battery unit and moves along the first axis.

5. The battery pack of claim 1, wherein the movable surface of the first side moves toward the second side of the same battery unit in which the first side is included and presses the electrode assembly between the first and second sides.

6. The battery pack of claim 1, wherein the first side further comprises a first edge portion surrounding the movable surface on the outer side of the movable surface which is relatively distant from the second side, and
the second side further comprises a second edge portion surrounding the protruding surface on the inner side of the protruding surface which is relatively close to the first side.

7. The battery pack of claim 6, wherein an exposed region of the movable surface exposed from the first edge portion and the protruding surface are formed at positions corresponding to each other.

8. The battery pack of claim 6, wherein the first edge portion is formed to be stepped from the movable surface toward the outer side away from the second side, and
the second edge portion is formed to be stepped from the protruding surface toward the inner side approaching the first side.

9. The battery pack of claim 6, wherein the case comprises a can integrally formed from the first edge portion of the first side to a side connecting the first side to the second side and the entire second side.

10. The battery pack of claim 1, wherein, in the arrangement of multiple battery units arranged along the first axis, the first and second sides are arranged alternately along the first axis.

11. The battery pack of claim 10, wherein, in the arrangement of multiple battery units arranged along the first axis, the first and second sides are placed at one end location and the other end location, respectively, which correspond to the outermost positions along the first axis.

12. The battery pack of claim 11, wherein, on the outside of the first side at the outermost location along the first axis, a pressure plate having a protruding surface for providing pressure to a movable surface of the first side is arranged.

13. The battery pack of claim 1, further comprising a binding mechanism that provides a binding force to physically bind multiple battery units arranged along the first axis.

14. The battery pack of claim 13, wherein the binding force provided by the binding mechanism is transmitted in the first axis in which the multiple battery units are arranged, providing a pressure that induces the positional movement of the movable surface in the first side in each battery unit.

15. The battery pack of claim 13, wherein the binding mechanism comprises:
a pair of end plates including a front end plate and a rear end plate respectively formed outside one end location and the other end location in the first axis, in the arrangement of multiple battery units arranged along the first axis; and
a pair of side plates extending across the sides of multiple battery units arranged along the first axis and connecting the front end plate to the rear end plate.

16. The battery pack of claim 15, wherein one end plate of the front end plate and the rear end plate comprises a protruding surface for providing pressure to the movable surface of the outermost first side along the first axis.

17. The battery pack of claim 1, wherein the movable surface provides elasticity or cushioning between adjacent battery units to absorb swelling of multiple battery units arranged along the first axis.

18. The battery pack of claim 17, wherein the movable surface comprises an elastic material.

19. The battery pack of claim 1, wherein the electrode assembly comprises multiple electrode layers stacked along the first axis.

20. The battery pack of claim 19, wherein the electrode assembly comprises an electrolyte layer between electrode layers of different polarities along the first axis, wherein
the electrolyte layer comprises a solid electrolyte.

21. The battery pack of claim 19, further comprising an alignment mechanism for aligning multiple electrode layers arranged along the first axis.

22. The battery pack of claim 21, herein the alignment mechanism comprises guide columns extending along the first axis to pass through corresponding positions of multiple electrode layers arranged along the first axis or corresponding positions of gaskets surrounding the outer circumferences of multiple electrode layers.

23. The battery pack of claim 22, wherein the electrode layer comprises first and second electrode layers of different polarities, and
the guide columns continuously pass through the first electrode layer and the gaskets surrounding the outer circumferences of the second electrode layer and align the first electrode layer with the second electrode layer surrounded by the gaskets.

24. The battery pack of claim 23, wherein the gasket comprises a central opening defining the correct location of the second electrode layer, and an edge surrounding the central opening.

25. The battery pack of claim 23, wherein the gasket comprises:
a pair of strips arranged to face each other while extending in a direction of the long side of the second electrode layer, and another pair of strips arranged to face each other while extending in a direction of the short side of the second electrode layer; and
through-holes formed at four corner positions where the pair of strips extending in the direction of the long side and another pair of strips extending in the direction of the short side come into contact with each other,
wherein the guide columns continuously pass through through-holes formed at four corner positions of the gaskets and through-holes formed at four corner positions of the second electrode layer.
